(19) United States
(12) Patent Application Publication
(10) Pub. No.: US 2009/0214145 A1
(43) Pub. Date: Aug. 27, 2009

(54) UNITARY OVERMOLD CENTER SUPPORT BEARING SUBASSEMBLY

(75) Inventors: Lawrence CISLO, Brighton, MI (US); Matthew SENDZIK, Waterloo (CA)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/201,750

(22) Filed: Aug. 29, 2008

Related U.S. Application Data
(60) Provisional application No. 60/973,219, filed on Sep. 18, 2007.

(51) Int. Cl. F16C 25/08; F16C 27/00

(52) U.S. Cl. 384/208; 384/536; 29/898.15

(57) ABSTRACT

The unitary center support bearing subassembly comprises a bearing over which a plastic bearing housing has been molded while simultaneously molding the plastic bracket insert and joining members which space and fix the distance between the bearing housing and the bracket insert. The joining members are removed or broken prior to molding the overmolded rubber portion, or, if the joining member is flexible, the overmolded rubber portion is molded while maintaining the joining member.

### FIELD OF THE INVENTION

This Invention relates to bearings and, more particularly, to a center support bearing subassembly for use in prop-shaft or drive-shaft applications.

### BACKGROUND OF THE INVENTION

Bearing subassemblies typically have a bearing mounted in a bearing housing and a bracket insert which is spaced apart from the bearing housing and affixed to the bearing housing by means of an overmolded rubber portion. The overmolded rubber portion provides flexing between the bearing and the bracket. The bearing housing and the bracket insert are typically separate components which are made in separate forming steps. The bearing housing is typically made from deep-drawn steel while the bracket insert is typically made of either deep-drawn steel or molded plastic.

FIG. 1 illustrates conventional bearing subassembly 10 having bearing 12 surrounded by bearing housing 14 which, in turn, is surrounded by overmolded rubber portion 16 which spaces and is molded to bracket insert 18.

The process to make a conventional bearing subassembly as illustrated in FIG. 1, entails manufacturing the bearing housing by deep-drawn steel; manufacturing a separate bracket insert, either by deep-drawn steel or plastic molding; molding the overmolded rubber portion around both the bearing housing and the bracket insert; then inserting the bearing into the bearing housing so as to form the bearing subassembly and then inserting the bearing subassembly into the bracket.

One of the problems associated with such conventional bearing subassemblies is that the bearing housing, which is made by deep-drawn steel, cannot be made with the necessary roundness and tolerance accuracy to prevent excessive preload of the bearing. Additionally, it can be seen that a plurality of steps are necessary for the assembly of the bearing subassembly.

### OBJECTS OF THE INVENTION

It is the object of the Invention to improve the fit between the bearing and the bearing housing so as to provide the necessary roundness and tolerance accuracies thereby preventing excessive preload of the bearing. Additionally, it is an object of the present Invention to reduce the number of steps necessary for making the bearing subassembly. These and other objects of the present Invention will be more readily apparent by reference to the following description of the Invention.

### SUMMARY OF THE INVENTION

The Invention achieves these objects and other objects by forming a unitary center support comprising a bearing housing, a bracket insert, and a joining member which spaces and fixes the distance between the bearing housing and the bracket insert. The unitary center support is molded in one step from plastic so as to form a single piece.

Suitably, the unitary center support is molded directly about a bearing so as to form a unitary overmolded center support bearing subassembly. The overmolded rubber portion is then subsequently molded in the space between the bracket insert and the bearing housing of the bearing subassembly. Alternatively, the unitary center support is molded over the outer portion of the bearing and then the remaining portions of the bearing are inserted into the outer portion of the bearing to form the unitary center support bearing subassembly onto which the overmolded rubber portion is overmolded. Yet another alternative is to mold the unitary center support by itself in a mold, press fit the bearing into the bearing housing to form the subassembly, and then overmold the overmolded rubber portion onto the subassembly.

The flexibility necessary between the bearing and the bracket is provided by the overmolded rubber portion. In order to prevent the plastic joining member from interfering with the duties of the overmolded rubber portion, the joining member can be completely removed before or during the rubber molding. Alternatively, the joining member is flexible such that it flexes with the overmolded rubber portion and, thus, does not interfere with the duties of the overmolded rubber portion. Another alternative for the joining member is that it breaks before or during the rubber molding process to leave gaps in the joining member thereby allowing the overmolded rubber portion to perform its flexing operation. Yet another alternative is to form the joining member with one or more weak spots such that the weak spots break or bends before or during the rubber molding process such that the joining member does not interfere with the duties of the overmolded rubber portion.

Preferably, the outer ring of the bearing has a protuberance or a groove and the plastic of the overmolded center support forms around the protuberance or into the groove. The interaction between the protuberance/groove and the molded plastic which forms around or in the protuberance or groove helps to maintain the position of the bearing housing and the bearing. Such an arrangement is preferred because the plastic of the bearing housing and the metal of the outer portion of the bearing have different coefficients of expansion. Thus, as the bearing heats and cools during operation, the bearing housing will maintain its orientation and position with respect to the bearing due to the interaction of the protuberance/groove and the molded plastic which forms around or in the protuberance or groove.

Suitably, the unitary center support is molded from plastic such as nylon 66, acetal plastic and polyester.

The present Invention can be defined as follows:

A unitary center support for a bearing subassembly in accordance with the present Invention can be defined as comprising:
(a) a plastic bearing housing for a bearing;
(b) a plastic bracket insert for a bracket; and
(c) a plastic joining member spaced between and fixing the distance between said bearing housing and said bracket insert.

A unitary center support bearing subassembly of the present Invention can be defined as comprising:
(a) a bearing;
(b) a plastic bearing housing on said bearing;
(c) a plastic bracket insert for a bracket; and
(d) a plastic joining member spaced between and fixing the distance between said bearing housing and said bracket insert.

The unitary center support bearing subassembly of the present Invention can further comprise an overmolded rubber portion which is spaced between said bearing housing and said bracket insert so as to provide flexing between the bearing and the bracket.

A method for making the unitary center support bearing subassembly of the present Invention comprises:
(a) molding, in a single step, a unitary center support for the bearing subassembly by molding plastic to form a bearing housing, a bracket insert and a plastic joining member spaced between and fixing the distance between the bearing housing and the bracket insert; and
(b) inserting a bearing into the bearing housing of the unitary center support so as to form a unitary center support bearing subassembly.

Alternatively, the unitary center support is molded directly onto the bearing itself or onto the outer portion of the bearing. When the unitary center support is molded onto the outer portion of the bearing itself, the remaining portion of the bearing are inserted into the outer portion to complete the subassembly.

A method for making a unitary center support bearing subassembly with an overmolded rubber portion in accordance with the present Invention comprises:

Steps (a) and (b), as recited above, followed by the following additional steps:
(c) molding rubber between said plastic bearing housing and said bracket insert.

The method of making a unitary center support bearing subassembly with overmolded rubber portion can further comprise either breaking the joining member before or during the molding of the rubber, or removing the joining member from the center support before molding the rubber.

These and other aspects of the present Invention may be more fully understood by reference to one or more of the following drawings.

### BRIEF DESCRIPTION OF THE DRAWINGS

FIG. 1 illustrates a conventional bearing subassembly;

FIGS. 2A and 2B illustrate a bearing subassembly of the Invention with a flexible joining member;

FIGS. 3A and 3B illustrate a bearing subassembly of the Invention with a removable web-shaped joining member;

FIG. 4 illustrates a bearing subassembly of the Invention with a broken or interrupted joining member;

FIG. 5 illustrates a bearing subassembly of the Invention with weak spots in the joining member; and

FIG. 6 illustrates a bearing subassembly of the Invention with an overmolded rubber portion therein.

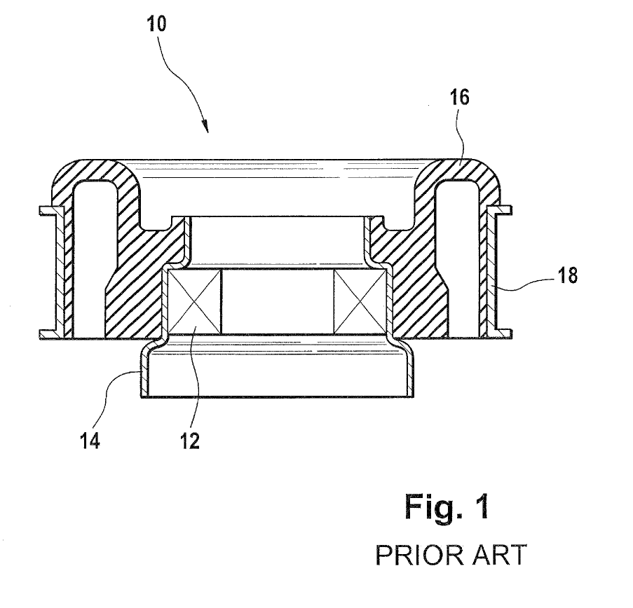

### DETAILED DESCRIPTION OF THE INVENTION

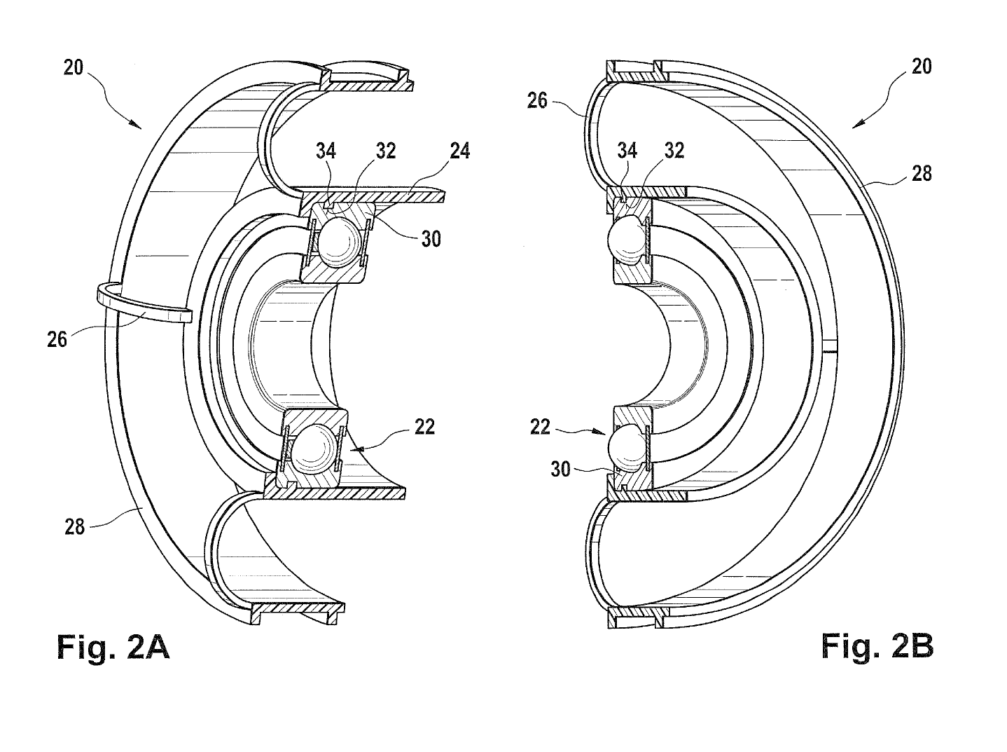

FIGS. 2A and 2B illustrate a bearing subassembly 20 of the Invention with bearing 22, plastic molded bearing housing 24 which are connected to flexible joining member 26 that connects to bracket insert 28. As can be seen, flexible joining member 26 can flex to accommodate movement between bearing housing 24 and bracket insert 28 such that flexible joining member 26 will work with an overmolded rubber portion which is illustrated in FIG. 6.

In order to maintain retention between the bearing housing and the bearing, outer ring 30 of bearing 22 has groove 32 formed therein. Groove 32 can also be referred to as a recessed knurl. As is illustrated in FIGS. 2A and 2B, plastic protuberance 34, which is part of bearing housing 24, extends into groove 32. The interaction between groove 32 and protuberance 34 retains the orientation and position of bearing housing 24 and outer ring 30. As will be understood by one of skill in the art, a protuberance in outer ring 30 can be employed which would then form a groove in bearing housing 24, however, it is preferred that the groove is formed in outer ring 30 and a protuberance is molded of plastic from bearing housing 24 as illustrated in FIGS. 2A and 2B.

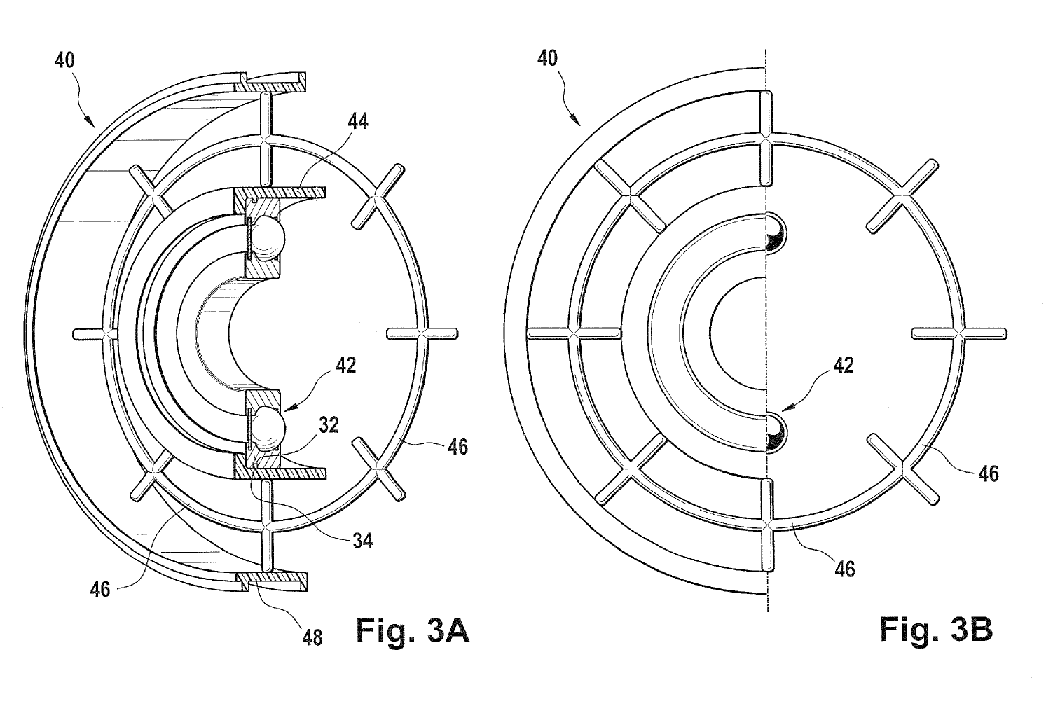

Turning to FIGS. 3A and 3B, bearing subassembly 40 is illustrated. Bearing subassembly 40 has bearing 42, plastic bearing housing 44, a plastic web joining member 46 and plastic bracket insert 48. Groove 32 and protuberance 34 are also illustrated.

Web joining member 46 is molded during the molding of the plastic when forming the center support for the bearing subassembly. Prior to molding the overmolded rubber portion between bearing housing 44 and bracket insert 48, web joining member 46 is removed.

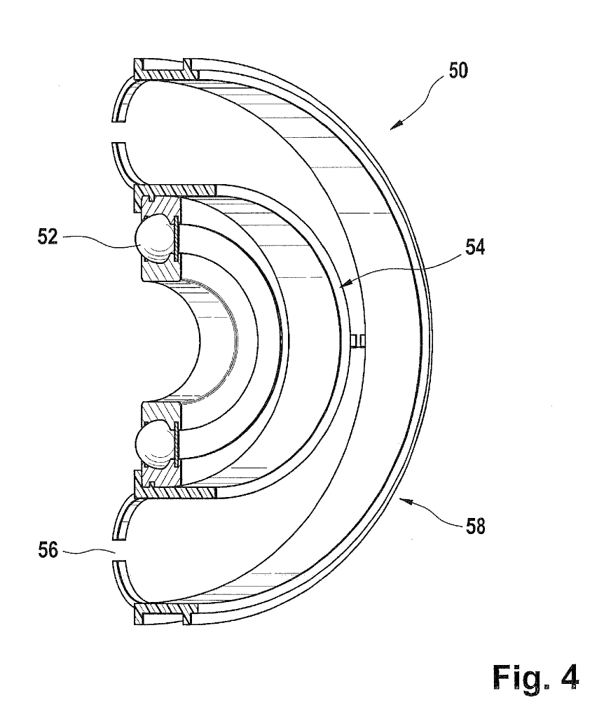

FIG. 4 illustrates bearing subassembly 50 having bearing 52, bearing housing 54, joining members 56 which are broken or interrupted as illustrated and bracket insert 58.

Joining member 56 is broken either before or during the molding process of the overmolded rubber portion. This will insure that the flexibility necessary for the overmolded rubber portion is not interfered with by the joining member.

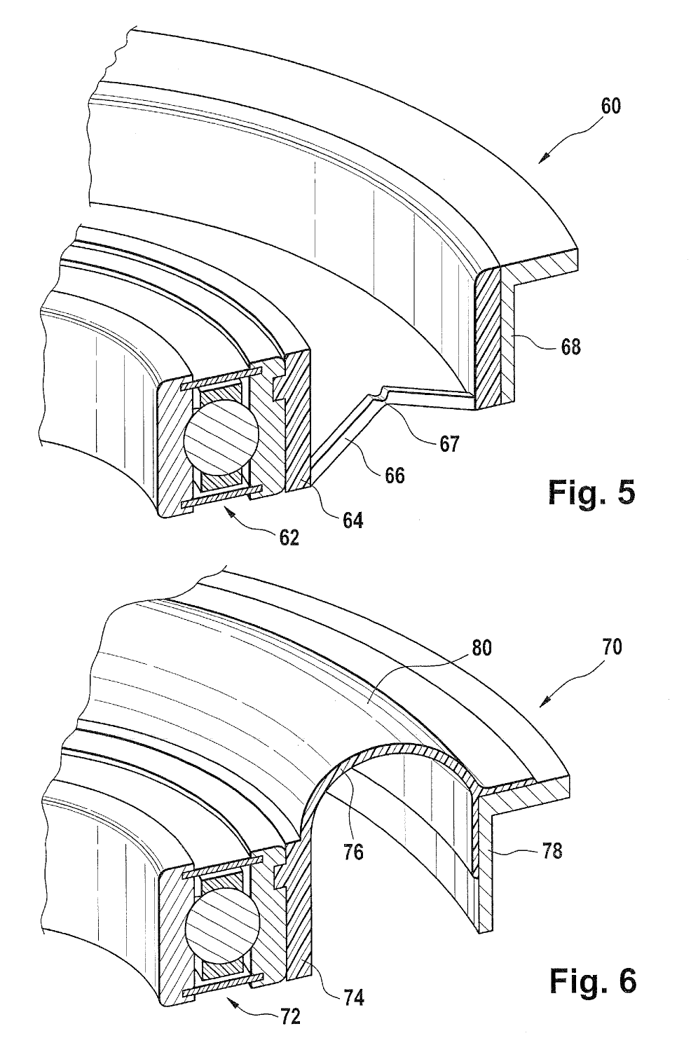

FIG. 5 illustrates bearing subassembly 60 with bearing 62, bearing housing 64, joining member 66 with weak spot 67 and bracket insert 68.

Weak spot 67 can break or bend before or during the molding of the overmolded rubber portion to insure the flexibility needed for the overmolded rubber portion.

FIG. 6 illustrates bearing subassembly 70 with bearing 72, bearing housing 74, joining member 76, bracket insert 78 and overmolded rubber portion 80. As can be seen, overmolded rubber portion 80 is molded about joining member 76.

In order to make a unitary center support for a bearing subassembly, plastic is injected into the plastic mold so as to form the bearing housing, joining member and bracket insert. Once the plastic has cooled, the unitary center support is removed from the mold and the bearing is press fitted into the bearing housing so as to form a unitary center support bearing subassembly. Subsequently, the unitary center support bearing subassembly is put into a rubber mold and rubber is injected so as to mold the overmolded rubber portion around the bearing housing and the bracket insert. This process can further comprise removing or breaking the joining member before the rubber molding step. Furthermore, the joining member can be broken during the rubber molding step. In the case where the joining member is flexible, the joining member need not be removed from the unitary center support.

Alternatively, the plastic mold is configured to hold either the outer ring of the bearing or the whole bearing, such that the plastic molding step entails molding the unitary center support on the bearing. If only the outer portion of the bearing is present during molding then the remaining portion of the bearing is added after the plastic has cooled.

The shape of the plastic mold for forming the unitary center support is dictated by the shape of the bearing housing, the shape of the bracket insert, the space between the bearing housing and the bracket insert, and the shape of the joining member. Design of such a mold as well as the overall process for injecting plastic is done in a conventional manner using conventional equipment.

The shape of the rubber mold for forming the overmolded rubber portion is dictated by the shape of the unitary center support bearing subassembly and the molding of the overmolded rubber portion is done in a conventional manner using conventional equipment.

Once the overmolded rubber portion has been molded into the unitary center support bearing subassembly, the subassembly with its overmolded rubber portion can then be mounted into the bracket.

### REFERENCE CHARACTERS

10 conventional bearing subassembly
12 bearing
14 bearing housing
16 overmolded rubber portion
18 bracket insert
20 bearing subassembly
22 bearing
24 plastic bearing housing
26 plastic flexible joining member
28 plastic bracket insert
30 outer ring
32 groove
34 protuberance
40 bearing subassembly
42 bearing
44 plastic bearing housing
46 plastic web joining member
48 plastic bracket insert
50 bearing subassembly
52 bearing
54 bearing housing
56 broken joining member
58 bracket insert
60 bearing subassembly
62 bearing
64 bearing housing
66 joining member
67 weak spot
68 bracket insert
70 bearing subassembly
72 bearing
74 bearing housing
76 joining member
78 bracket insert
80 overmolded rubber portion

What we claim is:

1. A unitary center support for a bearing subassembly comprising:
(a) a plastic bearing housing for a bearing;
(b) a plastic backing insert for a bracket; and
(c) a plastic joining member spaced between and fixing the distance between said bearing housing and said bracket inserts.

2. A unitary center support bearing subassembly comprising:
(a) a bearing;
(b) a plastic bearing housing on said bearing;
(c) a plastic bracket insert for a bracket; and
(d) a plastic joining member spaced between and fixing the distance between said bearing housing and said bracket insert.

3. The unitary center support bearing subassembly of claim 2, further comprising:
a groove in an outer portion of the bearing and a plastic protuberance on said plastic bearing housing extending into said groove.

4. A bearing subassembly of claim 2, further comprising:
an overmolded rubber portion between said bearing housing and said bracket insert.

5. A method for making a unitary center support bearing subassembly comprising:
(a) molding, in one step, a unitary center support by molding plastic to form a bearing housing while simultaneously forming a bracket insert and joining members which space and fix the distance between the bearing housing and the bracket insert; and
(b) inserting a bearing into the bearing housing of the unitary center support to form a unitary center support bearing subassembly.

6. The method of claim 5, further comprising the steps of
removing said joining member; and
molding rubber between said plastic bracket insert and said plastic bearing housing.

7. The method of claim 5, further comprising the steps of
breaking the joining member;
and molding rubber between said plastic bracket and said plastic bearing housing.

8. The method of claim 5, further comprising the steps of
molding rubber between said plastic bracket insert and said bearing housing.

9. A method for making a unitary center support bearing subassembly comprising:
(a) molding, in one step, a unitary center support for a bearing subassembly by molding plastic onto an outer portion of a bearing to form a bearing housing while simultaneously forming a bracket insert and joining members which space and fix the distance between the bearing housing and the bracket insert; and
(b) inserting remaining portions of the bearing into the bearing subassembly.

10. The method of claim 9, further comprising the steps of removing said joining member; and
molding rubber between said plastic bracket insert and said plastic bearing housing.

11. The method of claim 9, further comprising the steps of breaking the joining member;
and molding rubber between said plastic bracket and said plastic bearing housing.

12. The method of claim 9, further comprising the steps of molding rubber between said plastic bracket insert and said bearing housing.

13. A method for making a unitary center support bearing subassembly comprising:
molding, in one step, a unitary center support for a bearing subassembly by molding plastic onto a bearing to form a bearing housing while simultaneously forming a bracket insert and joining members which space and fix the distance between the bearing housing and the bracket insert to form a unitary center support and bearing subassembly.
